(19) United States
(12) Patent Application Publication
(10) Pub. No.: US 2026/0092564 A1
(43) Pub. Date: Apr. 2, 2026

(54) Heatshield Assembly for Gas Turbine Engines

(71) Applicant: RTX CORPORATION, Farmington, CT (US)

(72) Inventors: Todd A. DAVIS, Tolland, CT (US); Mark G. PAVLIK, Torrington, CT (US); Michael COMEAU, Manchester, CT (US); Connor MCGINLEY, Bloomfield, CT (US)

(21) Appl. No.: 18/904,746

(22) Filed: Oct. 2, 2024

(51) Int. Cl. F02C 7/24; F01D 25/12; F01D 25/18

(52) U.S. Cl. CPC F02C 7/24; F01D 25/125; F01D 25/18; F05D 2240/15; F05D 2260/231; F05D 2260/232; F05D 2260/98; F05D 2300/17; F05D 2300/603

(57) ABSTRACT

A device may include a gas turbine engine including a metallic tube. A device may include a heatshield assembly circumscribing the metallic tube, the heatshield assembly comprising: a metallic heatshield having a cylindrical body defined by a radially inner surface and a radially outer surface, the metallic heatshield supported on the metallic tube, and a fabric liner disposed between the radially inner surface and the metallic tube.

### BACKGROUND

This disclosure relates to gas turbine engines, and more particularly to lubricating various components of the engine.

Gas turbine engines typically include a compressor section and a turbine section. The air is compressed in the compressor section. From the compressor section the air is introduced into a combustor section where it is mixed with fuel and ignited in a combustor. Products of this combustion pass downstream over a turbine section to extract energy for driving the compressor section.

A bearing compartment typically houses various components like bearings, seals, and shafts that require cooling, lubrication, and sometimes sealing. Tubes within the bearing compartment serve as conduits for different types of fluids such as air, gas, or lubricant.

### SUMMARY

In some aspects, the techniques described herein relate to a gas turbine engine assembly including: a gas turbine engine including a metallic tube; and a heatshield assembly circumscribing the metallic tube, the heatshield assembly including: a metallic heatshield having a cylindrical body defined by a radially inner surface and a radially outer surface, the metallic heatshield supported on the metallic tube, and a fabric liner disposed between the radially inner surface and the metallic tube.

In some aspects, the techniques described herein relate to an assembly, wherein the cylindrical body of the metallic heatshield is provided by a first half portion and a second half portion.

In some aspects, the techniques described herein relate to an assembly, wherein the first half portion and the second half portion are coupled together by at least one strap.

In some aspects, the techniques described herein relate to an assembly, wherein the fabric liner includes at least two halves that are secured to the first half portion and the second half portion of the metallic heatshield.

In some aspects, the techniques described herein relate to an assembly, wherein the metallic heatshield is made of a nickel alloy.

In some aspects, the techniques described herein relate to an assembly, wherein the fabric liner includes a first insulating layer and a second insulating layer.

In some aspects, the techniques described herein relate to an assembly, wherein the first insulating layer is disposed on the metallic heatshield.

In some aspects, the techniques described herein relate to an assembly, wherein the second insulating layer contacts the metallic tube.

In some aspects, the techniques described herein relate to an assembly, wherein the second insulating layer is wear resistant.

In some aspects, the techniques described herein relate to an assembly, wherein the second insulating layer is made of a ceramic matrix composite (CMC) fabric or a polymer matrix composite (PMC) fabric.

In some aspects, the techniques described herein relate to an assembly, wherein the fabric liner is secured to the radially inner surface of the metallic heatshield by an adhesive, epoxy, or a mechanical connection.

In some aspects, the techniques described herein relate to an assembly, wherein the metallic tube has a first thickness, the metallic heatshield has a second thickness, the fabric liner has a third thickness, and the third thickness is greater than the first thickness and the second thickness.

In some aspects, the techniques described herein relate to an assembly, wherein the first thickness is between 0.028 inch and 0.035 inch, and the third thickness is between 0.074 inch and 0.430 inch.

In some aspects, the techniques described herein relate to an assembly, wherein the metallic tube is supported in a bearing compartment of the gas turbine engine.

In some aspects, the techniques described herein relate to an assembly, wherein the metallic tube includes oil supply pressure tube.

In some aspects, the techniques described herein relate to an assembly, wherein the metallic tube includes an oil scavenge tube.

In some aspects, the techniques described herein relate to an assembly, wherein the metallic tube includes a buffer tube.

In some aspects, the techniques described herein relate to an assembly, wherein the metallic tube includes a breather tube.

In some aspects, the techniques described herein relate to an assembly, wherein the metallic tube is made of a nickel alloy.

In some aspects, the techniques described herein relate to a gas turbine engine assembly including: a gas turbine engine including a metallic tube; and a heatshield assembly circumscribing the metallic tube, the heatshield assembly including: a metallic heatshield having a cylindrical body defined by a radially inner surface and a radially outer surface, the metallic heatshield supported on the metallic tube, and a fabric liner disposed between the radially inner surface and the metallic tube wherein there is a plurality of metallic tubes each with the heatshield assembly and in a bearing compartment of the gas turbine engine and including an oil supply pressure tube, an oil scavenge tube, a buffer tube, and a breather tube.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an example gas turbine engine.

FIG. 2 illustrates a bearing compartment bearing compartment.

FIG. 3 is a perspective view of a heatshield assembly on a tube.

FIG. 4 is a cross-sectional view taken along line 4-4 of FIG. 3.

FIG. 5 is a cross-sectional view taken along line 5-5 of FIG. 4.

FIG. 6 is a close-up view of FIG. 5.

FIG. 7 is an expanded view of the heatshield assembly and the tube of FIG. 3.

Like reference numbers and designations in the various drawings indicate like elements.

### DETAILED DESCRIPTION

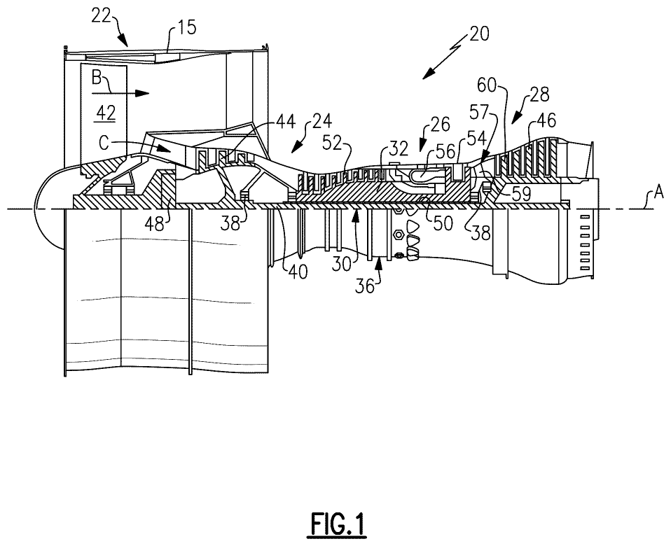

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The fan 42 may have at least 10 fan blades 43 but no more than 20 or 24 fan blades 43. In examples, the fan 42 may have between 12 and 18 fan blades 43, such as 14 fan blades 43. An exemplary fan size measurement is a maximum radius between the tips of the fan blades 43 and the engine central longitudinal axis A. The maximum radius of the fan blades 43 can be at least 40 inches, or more narrowly no more than 75 inches. For example, the maximum radius of the fan blades 43 can be between 45 inches and 60 inches, such as between 50 inches and 55 inches. Another exemplary fan size measurement is a hub radius, which is defined as distance between a hub of the fan 42 at a location of the leading edges of the fan blades 43 and the engine central longitudinal axis A. The fan blades 43 may establish a fan hub-to-tip ratio, which is defined as a ratio of the hub radius divided by the maximum radius of the fan 42. The fan hub-to-tip ratio can be less than or equal to 0.35, or more narrowly greater than or equal to 0.20, such as between 0.25 and 0.30. The combination of fan blade counts and fan hub-to-tip ratios disclosed herein can provide the engine 20 with a relatively compact fan arrangement.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49.

The low pressure compressor 44 and low pressure turbine 46 can include an equal number of stages. For example, the engine 20 can include a three-stage low pressure compressor 44, an eight-stage high pressure compressor 52, a two-stage high pressure turbine 54, and a three-stage low pressure turbine 46 to provide a total of sixteen stages. In other examples, the low pressure compressor 44 includes a different (e.g., greater) number of stages than the low pressure turbine 46. For example, the engine 20 can include a five-stage low pressure compressor 44, a nine-stage high pressure compressor 52, a two-stage high pressure turbine 54, and a four-stage low pressure turbine 46 to provide a total of twenty stages. In other embodiments, the engine 20 includes a four-stage low pressure compressor 44, a nine-stage high pressure compressor 52, a two-stage high pressure turbine 54, and a three-stage low pressure turbine 46 to provide a total of eighteen stages. It should be understood that the engine 20 can incorporate other compressor and turbine stage counts, including any combination of stages disclosed herein.

The engine 20 may be a high-bypass geared aircraft engine. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition typically cruise at about 0.8 Mach and about 35,000 feet (10,668 meters). The flight condition of 0.8 Mach and 35,000 ft (10,668 meters), with the engine at its best fuel consumption-also known as “bucket cruise Thrust Specific Fuel Consumption (‘TSFC’)” is the industry standard parameter of lbm of fuel being burned divided by lbf of thrust the engine produces at that minimum point. The engine parameters described above, and those in the next paragraph are measured at this condition unless otherwise specified.

“Fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40. “Corrected fan tip speed” is the actual fan tip speed in ft/sec divided by an industry standard temperature correction of [(Tram °R)/(518.7 °R)]0.5. The corrected fan tip speed can be less than or equal to 1150.0 ft/second (350.5 meters/second), and can be greater than or equal to 1000.0 ft/second (304.8 meters/second).

The fan 42, low pressure compressor 44 and high pressure compressor 52 can provide different amounts of compression of the incoming airflow that is delivered downstream to the turbine section 28 and cooperate to establish an overall pressure ratio (OPR). The OPR is a product of the fan pressure ratio across a root (i.e., 0% span) of the fan blade 43 alone, a pressure ratio across the low pressure compressor 44 and a pressure ratio across the high pressure compressor 52. The pressure ratio of the low pressure compressor 44 is measured as the pressure at the exit of the low pressure compressor 44 divided by the pressure at the inlet of the low pressure compressor 44. In examples, a sum of the pressure ratio of the low pressure compressor 44 and the fan pressure ratio is between 3.0 and 6.0, or more narrowly is between 4.0 and 5.5. The pressure ratio of the high pressure compressor ratio 52 is measured as the pressure at the exit of the high pressure compressor 52 divided by the pressure at the inlet of the high pressure compressor 52. In examples, the pressure ratio of the high pressure compressor 52 is between 9.0 and 12.0, or more narrowly is between 10.0 and 11.5. The OPR can be equal to or greater than 45.0, and can be less than or equal to 70.0, such as between 50.0 and 60.0. The overall and compressor pressure ratios disclosed herein are measured at the cruise condition described above, and can be utilized in two-spool architectures such as the engine 20 as well as three-spool engine architectures.

The engine 20 establishes a turbine entry temperature (TET). The TET is defined as a maximum temperature of combustion products communicated to an inlet of the turbine section 28 at a maximum takeoff (MTO) condition. The inlet is established at the leading edges of the axially forwardmost row of airfoils of the turbine section 28, and MTO is measured at maximum thrust of the engine 20 at static sea-level and 86 degrees Fahrenheit (° F). The TET may be greater than or equal to 2700.0° F., or more narrowly less than or equal to 3500.0° F., such as between 2750.0° F. and 3350.0° F. The relatively high TET can be utilized in combination with the other techniques disclosed herein to provide a compact turbine arrangement.

The engine 20 establishes an exhaust gas temperature (EGT). The EGT is defined as a maximum temperature of combustion products in the core flow path C communicated to at the trailing edges of the axially aftmost row of airfoils of the turbine section 28 at the MTO condition. The EGT may be less than or equal to 1000.0° F., or more narrowly greater than or equal to 800.0° F., such as between 900.0° F. and 975.0° F. The relatively low EGT can be utilized in combination with the other techniques disclosed herein to reduce fuel consumption.

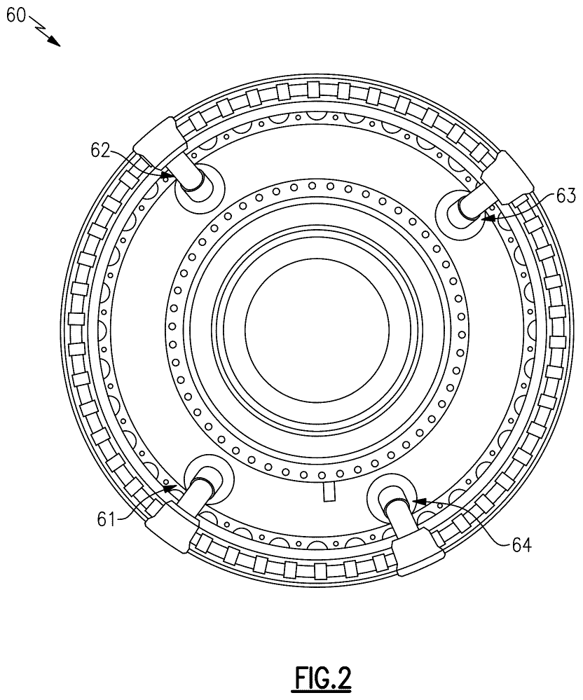

Referring to FIG. 2, with continuing reference to FIG. 1, a bearing compartment 60 is disclosed. The bearing compartment 60 may be incorporated into a gas turbine engine, such as one of the bearing systems 38. The bearing compartment 60 could also be associated with a bearing for the gear system 48. The bearing compartment 60 may receive lubricant (e.g., oil) from a lubricant source to lubricate one or more bearings in the bearing compartment 60 and/or provide cooling augmentation during operation of the engine 20. Air may also be supplied.

The bearing compartment 60 may include one or more metallic tubes for regulating conditions within the bearing compartment 60. In the embodiment of FIG. 2, the bearing compartment 60 may include a buffer tube 61, a breather tube 62, an oil supply pressure tube 63, and a scavenge tube 64. The buffer tube 61 may be operable to deliver pressurized air from the compressor section 24 to the bearing compartment 60 to form an air seal, which prevents the lubricant from leaking out of the bearing compartment 60. The breather tube 62 may be operable to manage the pressure inside the bearing compartment 60 by allowing air to exit the bearing compartment 60. The oil supply pressure tube 63 may be operable to deliver oil to the bearing compartment 60 for cooling and lubrication. The scavenge tube 64 may be operable to collect lubricant from the bearings and other components within the bearing compartment and direct the used lubricant to the lubricant source or a scavenge tank.

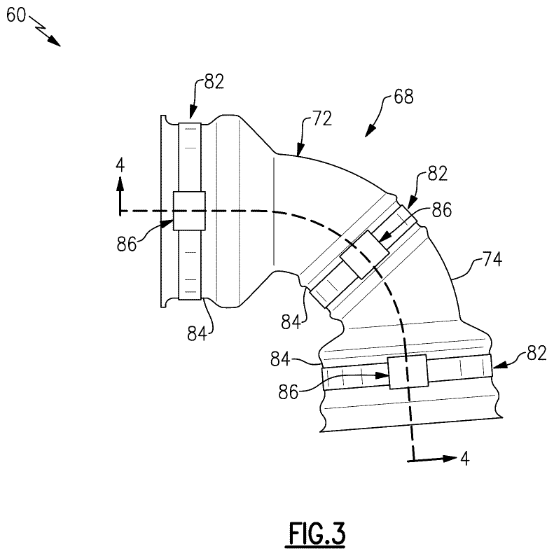

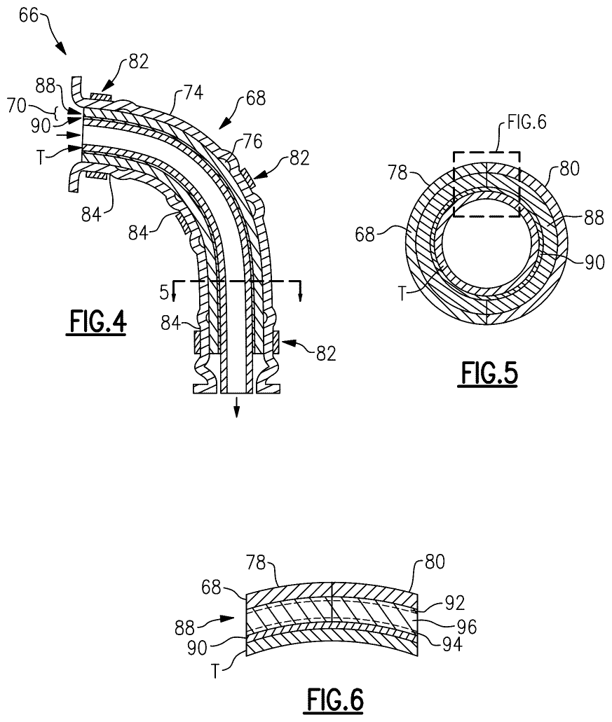

Referring to FIGS. 3 and 4, a heat shield assembly 66 is supported on a metallic tube T of the bearing compartment 60. The metallic tube T may serve as a conduit for communicating fluid (e.g., air, gas, or lubricant) toward and away from the bearing compartment 60. In an embodiment, the metallic tube T could be the buffer tube 61, the breather tube 62, the oil supply pressure tube 63, or the scavenge tube 64 (FIG. 2). In one embodiment, the metallic tube T may be made of a nickel alloy, such as nickel 718.

The heat shield assembly 66 may be an insulating blanket or foil configured to provide thermal protection for the metallic tube T. The heat shield assembly 66 may be sized and shaped to conform to the geometry of the metallic tube T. In the illustrated embodiment, the heat shield assembly 66 may circumscribe the metallic tube T.

As shown in FIGS. 4-7, the heat shield assembly 66 includes a metallic heatshield 68 and a fabric liner 70. The metallic heatshield 68 circumscribes the metallic tube T and the fabric liner 70. The metallic heatshield 68 includes a cylindrical body 72 (FIG. 3) defined by a radially outer surface 74 and a radially inner surface 76. The metallic heatshield 68 may be made of a nickel alloy, such as nickel 625.

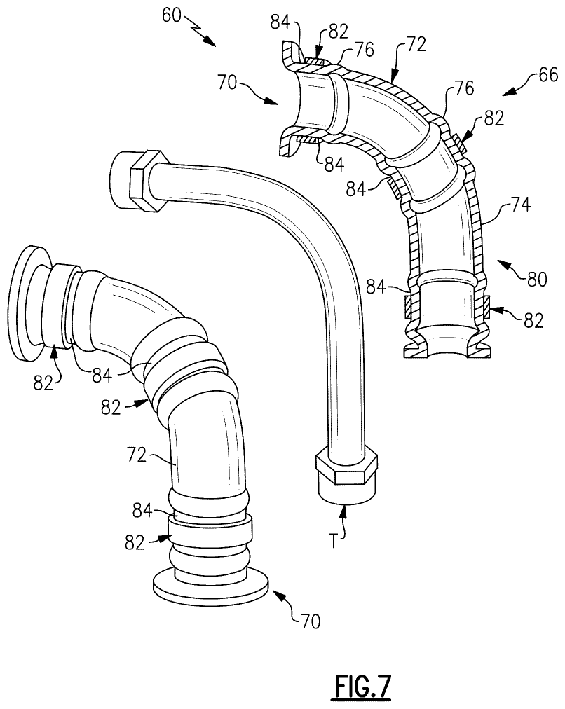

The cylindrical body 72 may be divided into a first half portion 78 and a second half portion 80 (FIGS. 5 and 7). The first half portion 78 and the second half portion 80 are coupled or otherwise held together by one or more straps 82 that are disposed along an outer periphery (i.e., along the radially outer surface 74 of the metallic heatshield 68). The straps 82 may be received or otherwise installed in one or more recessed areas 84 defined along the radially outer surface 74.

Returning to FIG. 3, each of the straps 82 may be held in direct contact on the metallic heatshield 68 by a locking mechanism 86 that is integral to each strap 82 (i.e., the straps 82 are self-locking). The straps 82 may be flexible. As the engine 20 heats up and cools down, the metallic heatshield 68 may experience thermal expansion and contraction and vibrations. The flexibility of the straps 82 allows the straps 82 to accommodate these changes or movements while maintaining a secure hold on the first and second half portions 78, 80 of the metallic heatshield 68 around the metallic tube T. Additionally, the straps 82 facilitate easier adjustment, replacement, and maintenance of the heatshield assembly 66 and the straps 82. For instance, the straps 82 may be removed without requiring extensive disassembly of surrounding components. The ability to easily replace the straps 82 also means that the heatshield assembly 66 can be maintained more effectively.

In an embodiment, the straps 82 and the locking mechanisms 86 may be made of a stainless steel or nickel alloy.

Each of the recessed areas 84 may be formed around the circumference of the metallic heatshield 68. The recesses areas 84 may be spaced apart or vary in distance. Each of the recessed areas 84 may have a depth and width sufficient to receive one of the straps 82 and prevent the straps 82 from sliding on the metallic heatshield 68 beyond the recessed area 84.

The fabric liner 70 may include at least two halves that are secured the first and second half portions 78, 80 of the metallic heatshield 68. The fabric liner 70 may be disposed on the radially inner surface 76 of the metallic heatshield 68. The fabric liner 70 may be interfaced or otherwise sandwiched between the metallic tube T and the metallic heatshield 68. In an embodiment, the fabric liner 70 may be secured to the radially inner surface 76 of the metallic heatshield 68 by an adhesive, epoxy or a mechanical connection.

In one embodiment, the fabric liner 70 may include a first insulating layer 88 that is disposed on the radially inner surface 76 of the metallic heatshield 68 and a second insulating layer 90 that contacts the metallic tube T. The first insulating layer 88 may be configured to provide a thermal barrier between the metallic tube T and the metallic heatshield 68. The first insulating layer 88 may be multi-layered. In an embodiment, the first insulating layer 88 may include a first foil layer 92 disposed on the radially inner surface 76 of the metallic heatshield 68, a second foil layer 94 disposed on the second insulating layer 90, and an intermediate layer 96 sandwiched between the first foil layer 92 and the second foil layer 94. The first and second foil layers 92, 94 may be made of a nickel alloy, such as nickel 625. The intermediate layer 96 may be made of a low thermal conductivity fiber felt material having a ceramic or glass fabric facing. The second insulating layer 90 may be wear resistant and configured to prevent metal-on-metal contact between the metallic tube T and the metallic heatshield 68. In an embodiment, the second insulating layer 90 may be made of a ceramic matrix composite (CMC) fabric or a polymer matrix composite (PMC) fabric. In an embodiment, the fabric or cloth may be available under the trademark Nextel™ 312 from 3M™.

In an embodiment, the metallic tube T has a first thickness T1, the metallic heatshield 68 has a second thickness T2, and the fabric liner 70 has a third thickness T3, and the third thickness T3 is greater than the first thickness T1 and the second thickness T2. In one embodiment, the first thickness T1 may be between 0.028 inch (or 0.711 mm) and 0.035 inch (or 0.889 mm), and the third thickness T3 may be between 0.074 inch (or 1.880 mm) and 0.430 inch (or 10.922 mm).

In an embodiment, the thickness of the first insulating layer 88 of the fabric liner 70 may be greater than the thickness of the second insulating layer 90 of the fabric liner 70. In one embodiment, the first insulating layer 88 may have a thickness between 0.069 inch (or 1.753 mm) and 0.405 inch (or 10.287 mm) and the second insulating layer 90 may have a thickness between 0.005 inch (or 0.127 mm) and 0.025 inch (or 0.635 mm). In a further embodiment, the first and second foil layers 92, 94 may each have a thickness between 0.003 inch (or 0.076 mm) and 0.015 inch (or 0.381 mm) and the fabric layer 96 may have a thickness between 0.063 inch (or 1.600 mm) and 0.375 inch (or 9.525 mm).

In one embodiment, the tube T and the fabric liner 70 may be encased in a shell that has a thickness between 0.012 inch (or 0.305 mm) and 0.020 inch (or 0.508 mm).

A method of assembling the heatshield assembly 66 on the metallic tube T will be described with reference to FIGS. 3, 4, and 7. The cylindrical body 72 of the metallic heatshield 68 is provided by the first half portion 78 and the second half portion 80. The first insulating layer 88 of the fabric liner 70 is then disposed on the radially inner surface 76 of the metallic heatshield 68. The metallic heatshield 68 is thereafter situated around the metallic tube T such that the second insulating layer 90 of the fabric liner 70 contacts the metallic tube T. Once the heatshield assembly 66 circumscribes the metallic tube T, the first half portion 78 and the second half portion 80 are coupled together by the straps 82.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason, the appended claims should be studied to determine true scope and content.

What is claimed is:

1. A gas turbine engine assembly comprising:
a gas turbine engine including a metallic tube; and
a heatshield assembly circumscribing the metallic tube, the heatshield assembly comprising:
a metallic heatshield having a cylindrical body defined by a radially inner surface and a radially outer surface, the metallic heatshield supported on the metallic tube, and
a fabric liner disposed between the radially inner surface and the metallic tube.

2. The assembly as recited in claim 1, wherein the cylindrical body of the metallic heatshield is provided by a first half portion and a second half portion.

3. The assembly as recited in claim 2, wherein the first half portion and the second half portion are coupled together by at least one strap.

4. The assembly as recited in claim 3, wherein the fabric liner includes at least two halves that are secured to the first half portion and the second half portion of the metallic heatshield.

5. The assembly as recited in claim 1, wherein the metallic heatshield is made of a nickel alloy.

6. The assembly as recited in claim 1, wherein the fabric liner includes a first insulating layer and a second insulating layer.

7. The assembly as recited in claim 6, wherein the first insulating layer is disposed on the metallic heatshield.

8. The assembly as recited in claim 6, wherein the second insulating layer contacts the metallic tube.

9. The assembly as recited in claim 8, wherein the second insulating layer is wear resistant.

10. The assembly as recited in claim 8, wherein the second insulating layer is made of a ceramic matrix composite (CMC) fabric or a polymer matrix composite (PMC) fabric.

11. The assembly as recited in claim 1, wherein the fabric liner is secured to the radially inner surface of the metallic heatshield by an adhesive, epoxy, or a mechanical connection.

12. The assembly as recited in claim 1, wherein the metallic tube has a first thickness, the metallic heatshield has a second thickness, the fabric liner has a third thickness, and the third thickness is greater than the first thickness and the second thickness.

13. The assembly as recited in claim 12, wherein the first thickness is between 0.028 inch and 0.035 inch, and the third thickness is between 0.074 inch and 0.430 inch.

14. The assembly as recited in claim 1, wherein the metallic tube is supported in a bearing compartment of the gas turbine engine.

15. The assembly as recited in claim 14, wherein the metallic tube includes oil supply pressure tube.

16. The assembly as recited in claim 14, wherein the metallic tube includes an oil scavenge tube.

17. The assembly as recited in claim 14, wherein the metallic tube includes a buffer tube.

18. The assembly as recited in claim 14, wherein the metallic tube includes a breather tube.

19. The assembly as recited in claim 1, wherein the metallic tube is made of a nickel alloy.

20. A gas turbine engine assembly comprising:
a gas turbine engine including a metallic tube; and
a heatshield assembly circumscribing the metallic tube, the heatshield assembly comprising:
a metallic heatshield having a cylindrical body defined by a radially inner surface and a radially outer surface, the metallic heatshield supported on the metallic tube, and
a fabric liner disposed between the radially inner surface and the metallic tube
wherein there is a plurality of metallic tubes each with the heatshield assembly and in a bearing compartment of the gas turbine engine and including an oil supply pressure tube, an oil scavenge tube, a buffer tube, and a breather tube.
